(19) United States
(12) Patent Application Publication
(10) Pub. No.: US 2005/0089014 A1
(43) Pub. Date: Apr. 28, 2005

(54) System and methods for communicating over the internet with geographically distributed devices of a decentralized network using transparent asymetric return paths

(75) Inventors: Steven L. Levin, Sunnyvale, CA (US); Jonathan Disher, Sunnyvale, CA (US)

Correspondence Address: PATENT DEPARTMENT;MACROVISION CORPORATION, 2830 DE LA CRUZ BLVD., SANTA CLARA, CA, 95050, US

(73) Assignee: MACROVISION CORPORATION, Santa Clara, CA (US)

(21) Appl. No.: 10/869,208

(22) Filed: Jun. 16, 2004

Related U.S. Application Data
(60) Provisional application No. 60/514,672, filed on Oct. 27, 2003.

(51) Int. Cl. H04L 12/28

(52) U.S. Cl. 370/351; 370/392

(57) ABSTRACT

A system and methods for communicating over the Internet with devices of a decentralized network using transparent asymmetric return paths are described. Remote capture centers are geographically distributed so as to communicate with devices of a decentralized network that reside in diverse geographical locations. A centralized data center communicates with the remote capture centers so as to generate processed information in the form of reply packets from information received at the remote capture centers from the devices, and transmit the processed information back to the devices in a manner so that the processed information appears to have been transmitted from the remote capture centers.

### CROSS REFERENCE TO RELATED APPLICATIONS

This application claims priority to U.S. provisional application Ser. No. 60/514,672 filed Oct. 27, 2003.

### FIELD OF THE INVENTION

The present invention generally relates to communicating with devices of a decentralized network and in particular, to a system and methods for communicating over the Internet with geographically distributed devices of a decentralized network using transparent asymmetric return paths.

### BACKGROUND OF THE INVENTION

A decentralized network such as peer-to-peer file sharing networks employing the Internet may connect millions of devices around the world together for the sharing of information. A system that monitors certain aspects of such sharing should have a global presence that covers the geographical span of the decentralized network.

Because of the way most peer-to-peer networks function, efficiently of operation is best achieved by the system having a presence on globally diverse networks, especially in major metropolitan areas where there is a significant broadband penetration. This presents a system architecture problem, however, where a lean system is desired that is relatively cheap to implement and easy to maintain.

Traditional methods of structuring such a system involve either the deployment of large numbers of expensive clusters, or backhauling expensive data circuits from many global points of presence back to a central datacenter. Each of these methods, however, is very costly.

In particular, the deployment of many clusters of machines in many locations around the world on diverse networks is extremely expensive to implement, difficult to manage, and highly inefficient. It also does not scale well since a lack of resources in one point of presence cannot easily be compensated for with a glut of resources in another location.

A backhauled data circuit, on the other hand, that is deployed to peer with many networks on a global scale is usually even more cost prohibitive since routers and long-haul circuits are expensive, and peering arrangements generally take large amounts of time and money to complete.

In addition, in monitoring the information sharing activity in a decentralized network, it may be useful for a system to include agents to masquerade as one or more devices in the decentralized network. In such a system, communications with the devices should use either a symmetric return path (i.e., the agent receiving the original communication from a device returns any reply generated by a centralized data center back to the device) or use a transparent asymmetric return path (i.e., the centralized data center returns to the reply to the device directly, but in such a fashion that it appears to the device that the reply is being sent by the agent) in order to maintain the agent's masquerade.

### OBJECTS AND SUMMARY OF THE INVENTION

Accordingly, one object of the present invention is to provide a system and methods for communicating over the Internet with geographically distributed devices of a decentralized network.

Another object is to provide a system and methods for communicating over the Internet with geographically distributed devices of a decentralized network that is relatively cheap to implement and easy to maintain.

Another object is to provide a system and methods for communicating over the Internet with geographically distributed devices of a decentralized network that is scaleable and efficiently manages system resources.

Still another object is to provide a system and methods for communicating over the Internet with devices of a decentralized network that is compatible with the use of agents masquerading as devices of the decentralized network in order to monitor and/or perform other functions related to information or file sharing in the decentralized network.

Yet another object is to provide a system and methods for communicating over the Internet with devices of a decentralized network using transparent asymmetric return paths.

These and other objects are accomplished by the various aspects of the present invention, wherein briefly stated, one aspect is a system for communicating with geographically distributed devices in a decentralized network, comprising: remote capture centers geographically distributed so as to receive communications from devices of a decentralized network that reside in diverse geographical locations; and a centralized data center communicating with the remote capture centers so as to generate processed information from the communications received at the remote capture centers from the devices and transmit the processed information back to the devices such that the processed information appears to have been transmitted from the remote capture centers.

Another aspect is a method for communicating with devices in a decentralized network, comprising: receiving a packet from a device; routing the packet to a centralized data center; generating a reply packet by processing information in the packet; and transmitting the reply packet back to the device using a transparent asymmetric return path.

Another aspect is a method for communicating with devices in a decentralized network, comprising: receiving a request to establish a virtual circuit including a first computer in a remote capture center, a second computer in a centralized data center, and an application computer initiating the request; and sending first re-write rules to the first computer and second re-write rules to the second computer when establishing the virtual circuit so that the first re-write rules cause the first computer to re-write a destination address included in a packet of information received from a device in the decentralized network to be re-written from an original destination address to an address associated with the second computer, and the second re-write rules cause the second computer to re-write the destination address from the address associated with the second computer to an address associated with the application computer after receiving the packet from the first computer.

Yet another aspect is a method for generating a reply packet, comprising: receiving a packet from a remote capture center that has re-written a destination address in the packet from an original destination address associated with the remote capture center to an address associated with a first node of a centralized network; re-writing the destination address from the address associated with the first node to an address associated with a second node of the centralized network; routing the packet over the centralized network to the second node according to a static route defined in a routing table of the first node; and generating a reply packet by processing information in the packet using an application program residing on the second node.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of a system for communicating with devices of a decentralized network organized into geographical regions, utilizing aspects of the present invention.

FIG. 2 illustrates a block diagram detailing a portion of the system for communicating with devices of one geographical region of the decentralized network, utilizing aspects of the present invention.

FIG. 3 illustrates a flow diagram of a method for activating a virtual circuit, utilizing aspects of the present invention.

FIG. 4 illustrates a flow diagram of a method for releasing an active virtual circuit, utilizing aspects of the present invention.

FIG. 5 illustrates a flow diagram of a first method for transmitting information to set-up a virtual circuit, utilizing aspects of the present invention.

FIG. 6 illustrates a flow diagram of a method for communicating over the Internet with devices of a decentralized network, corresponding to the virtual circuit set-up described in FIG. 5 and utilizing aspects of the present invention.

FIG. 7 illustrates a flow diagram of a second method for transmitting information to set-up a virtual circuit, utilizing aspects of the present invention.

FIG. 8 illustrates a flow diagram of a method for communicating over the Internet with devices of a decentralized network, corresponding to the virtual circuit set-up described in FIG. 7 and utilizing aspects of the present invention.

### DETAILED DESCRIPTION OF THE PREFERRED EMBODIMENT

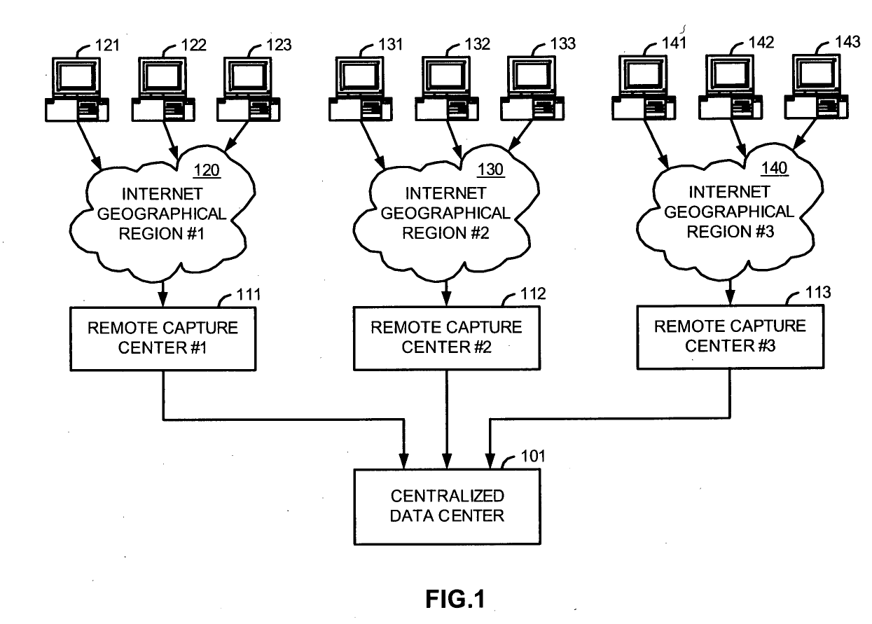

FIG. 1 illustrates, as an example, a block diagram of a system configured to implement the various methods described herein that are applicable to communicating over the Internet with devices of a decentralized network over the Internet. The system includes a centralized data center 101 and a plurality of remote capture centers such as 111˜113 that are geographically distributed so as to receive communications from devices in their respective geographical regions. Each remote capture center may be thought of in this case as a conventional point of presence (“POP”) that provides an access point to the Internet.

In the example, the locations of the devices are organized into three geographical regions according to their IP addresses. In a first geographical region 120, a first remote capture center 111 is physically located so as to receive packets of information from a number of devices such as computers 121˜123. Likewise, in a second geographical region 130, a second remote capture center 112 is physically located so as to receive packets of information from a number of devices such as computers 131˜133. Finally, in a third geographical region 140, a third remote capture center 113 is physically located so as to receive packets of information from a number of devices such as computers 141˜143. In an actual implementation, additional remote capture centers may be deployed to cover additional geographical regions so as to provide a truly global presence for the system.

The remote capture centers send their received packets of information over the Internet to the centralized data center 101 for processing. The transmission may be over the public Internet or a Virtual Private Network (“VPN”). In either case, since the Internet is used instead of routers and a leased line, high costs associated with a backhauled data circuit are avoided. Also, since the processing of packets is performed at the centralized data center 101 instead of the remote capture centers, this makes the system relatively inexpensive to implement since it only requires deployment of a few relatively cheap and less powerful machines in each of the remote capture centers (usually 3 or 4 per POP).

The system is also scaleable and relatively more efficient to manage since processing can be easily distributed between computation machines in the centralized data center 101 to balance their work loads. Further, resources can be added when overall system demands require it at one location (i.e., the centralized data center 101) rather than at many distant locations (i.e., the remote capture centers) where they may wind up being under or over utilized. Thus, the system avoids the drawbacks associated with an approach that deploys many clusters of machines around the world without central processing.

After processing the packets, the centralized data center 101 transmits reply packets back to the devices directly rather than sending them back through the original routes from which they came. Thus, asymmetric return paths are used in the system to avoid burdening the remote capture centers with a relay function and to save reply packet transit time. Since the devices receiving the reply packets expect the reply packets to come from the destination IP addresses to which the original packets were sent, the centralized data center 101 transmits these packets back to the devices in such a manner that the reply packets-appear to have come from their respective destination IP addresses, thereby making the asymmetric return paths transparent to these devices.

Thus, the system transparently intercepts and transits unidirectional or bidirectional streams of data from one location to another with an asymmetric return path. Its primary function is to allow a broad geographic presence without deploying a large infrastructure in multiple remote locations around the globe. A secondary benefit of the system is its ability to masquerade it processing and transmission location securely behind the identity of the remote endpoint (i.e., an IP address associated with one of its remote capture center).

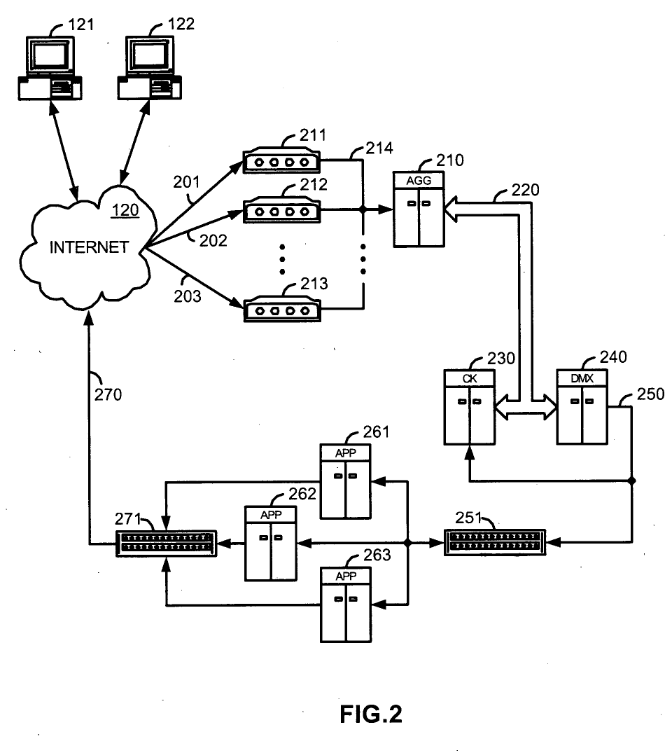

FIG. 2 illustrates, as an example, a block diagram including a portion of the system for communicating with devices such as computer 121 in the first geographical region 120. In the example, multiple DSL lines such as 201˜203 are brought in, usually using Point-to-Point Protocol over Ethernet (“PPPoE”) as a transport, from multiple DSL service providers (such as Speakeasy, EarthLink, Covad, SBC, BT, Telewest, NTL, SingTel or Telestra) to their respective DSL modems such as 211˜213 in the remote capture center 111. This arrangement provides IP address diversity while at the same time allows realistic simulation of an average device in a decentralized network of interest. Although the use of DSL is shown throughout this example, other mediums such as T1, ISDN, cable modem, Ethernet handoff, and even dial-up may also be used.

The DSL modems are connected over Ethernet 214 (e.g.,100BaseTX) to an aggregator computer 210, which is also in the remote capture center 111. Although only one such aggregator is shown in this example, in practice, multiple aggregators may be used in each remote capture center. The aggregators may typically have no more than 8 or 9 DSL modems connected to them (using quad-port PCI Ethernet network interface cards for port density). Due to the nature of PPPoE, the DSL modems are preferably connected to the Ethernet ports on the aggregator 210, not aggregated by a switch.

The aggregator computer 210 takes each incoming packet off Ethernet 214 and its packet filter rewrites a destination address in the packet from an original destination address associated with the remote capture center 111 to an address associated with the centralized data center 101 according to re-write rules previously provided to the aggregator 210 as part of setting up a virtual circuit between the aggregator computer 210 and an application computer in the centralized data center 101 which is to process the packet. The original destination address in this case is the IP address of the DSL modem that received the packet, which is typically provided by the DSL service provider.

The header of an IP packet conventionally includes both a source IP address indicating where the packet originated from (i.e., the sending node), and a destination IP address indicating where the packet is to go (i.e., the receiving node). A header checksum is also included to ensure IP header integrity. When replacing the original destination address with the aliased address, the checksum may also be changed accordingly to maintain header integrity.

After rewriting the destination address indicated in the packet, the packet is passed to the kernel of the aggregator computer 210 which determines that the destination address is not a local address so it routes the packet over a VPN tunnel 220 (using IPSEC or PPTP) to the demux computer 240 in the centralized data center 101 according to a static route defined in a routing table of the aggregator computer 210 at the time that the virtual circuit was set-up. In this case, the address associated with the demux computer 240 is a private range address, such as an aliased address dedicated to the virtual circuit. Although use of a VPN tunnel is preferred for security reasons, communications can also be performed by the aggregator computer 210 routing the packet over the public Internet without a VPN tunnel to a public range address on the demux computer 240.

After receiving the packet, a packet filter of the demux computer 240 rewrites the destination address from the address associated with the demux computer 240 to an address associated with the application computer which is to process the packet, according to re-write rules previously provided to the demux computer 240 as part of setting up the virtual circuit. The packet is then passed to the kernel of the demux computer 240, which determines that the destination address is not a local address so it routes the packet over Ethernet 250 to the application computer that is to process the packet, using another static route defined in a routing table of the demux computer 240 at time that the virtual circuit was set up. The application computer in this case has a resident application program which has initiated the virtual circuit and will process the packet.

Once the packet is passed to the application computer, its kernel determines that the destination address matches a local address, and passes the packet to the application program which is to process the packet. The application program in this case is the one that originally requested that the virtual circuit be set up, and the kernel recognizes that application program, because it is bound to the address currently in the destination address of the packet and to the proper port of the application computer.

After processing the packet to generate a reply packet, the application program sends the reply packet out the application computer's public IP interface or default gateway (using, for example, a Gig-E or OC-48 uplink) back to the device that originally sent the packet to the remote capture center 111. The reply packet received by the device will have the source IP address in the originally received packet (i.e., the IP address of the computer 121 which originally sent the packet) as its destination IP address, and the destination IP address in the originally received packet (i.e., the IP address of the receiving DSL modem) as its source IP address. Thus, the reply packet is returned using a transparent asymmetric return path.

A key part of the system is an automatic circuit management function performed by an administrative node 230, which is also referred to herein as the circuit keeper. The circuit keeper 230 maintains a list of active virtual circuits (i.e., virtual circuits that are currently in use) and a list of available virtual circuits (i.e., virtual circuits that are currently available to be assigned for use). Each virtual circuit defines a path of transmission for a packet, starting with a computer in the remote capture center that is to receive packets from devices in a decentralized network, and ending with an application computer that is to process the packet.

The circuit keeper computer 230 includes automated administration tools, which are responsible for building up and tearing down transit connections from end to end on a dynamic basis. Since DSL is not as reliable as the carrier class connectivity solutions (such as T1), it is not unusual for a virtual circuit connection to bounce up and down in a relatively short period of time. Therefore, the automated administration tools are able to automate the process of: connecting to the DSL provider, authenticating, getting an IP address, setting up the end-to-end rewrite rules and static routes on computers associated with the virtual circuit, and monitoring link availability. To do so, the automated administration tools are configured to bring up DSL connections on the aggregator computer 210, maintain tables of available and active virtual circuits, IP addresses and rewrite rules, and pass virtual circuit set-up information on to computers associated with the virtual circuit.

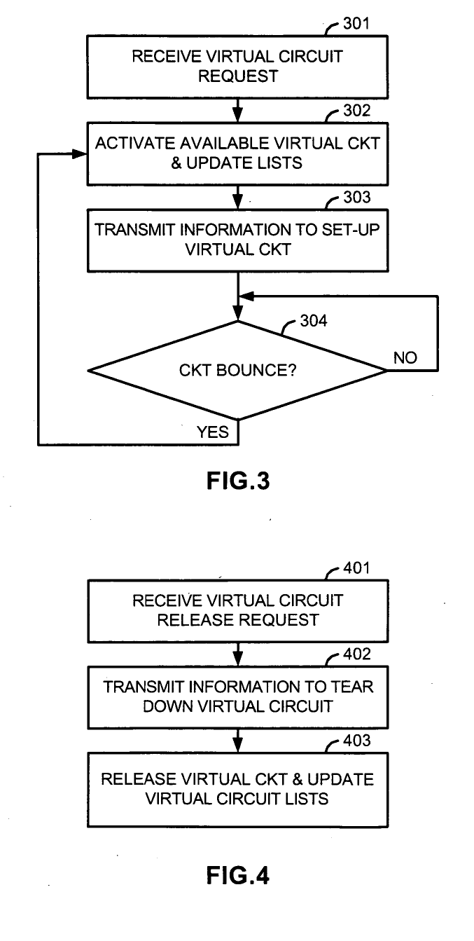

FIG. 3 illustrates, as an example, a flow diagram of a method for activating a virtual circuit that facilitates setting up various static routes and re-write rules on computers associated with the virtual circuit. In 301, the circuit keeper computer 230 receives a request to activate an available virtual circuit. The request in this case commonly comes from an application program acting as an agent that will process incoming packets through a designated modem or remote capture center. In 302, if the virtual circuit is available (i.e., not currently being used), then the circuit keeper computer 230 activates the virtual circuit and updates the active and available virtual circuit lists accordingly.

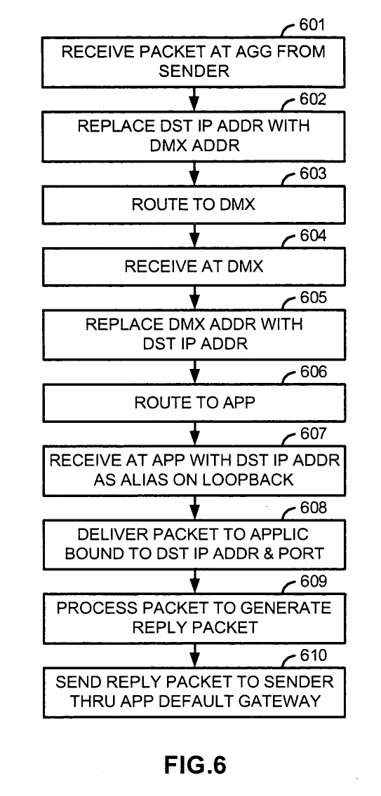

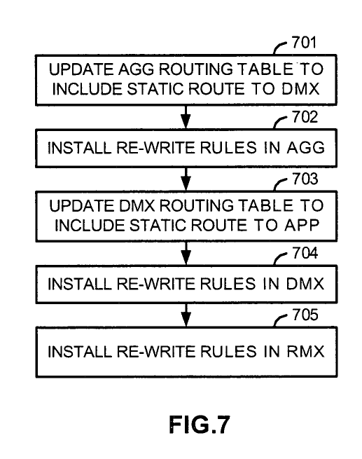

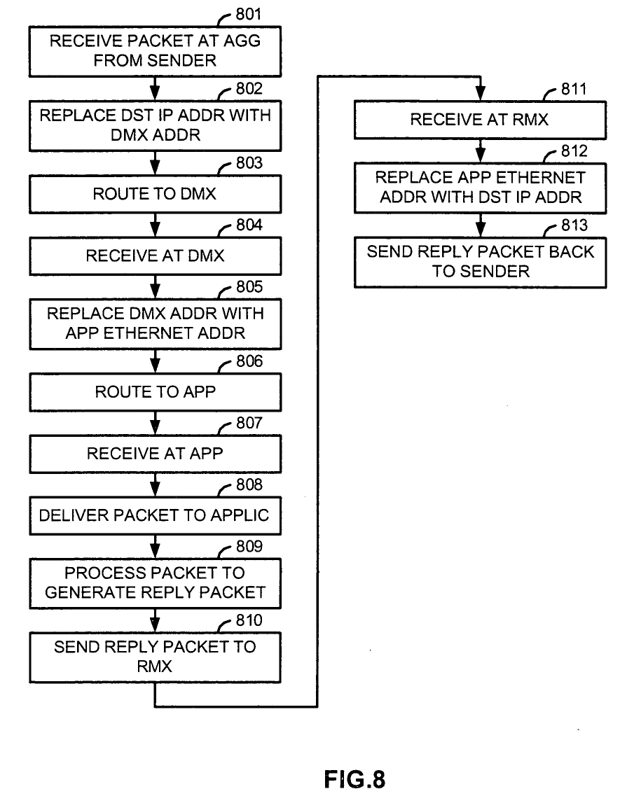

As previously described, the virtual circuit defines a path of transit for the packet, which is preferably specified in the form of static routes. In 303, the circuit keeper 230 transmits information to computers associated with the virtual circuit to set up the virtual circuit. The specific information transmitted and the recipients of that information depend upon the method being used to communicate with devices of a decentralized network using transparent asymmetric return paths. As will be described below, an example of one such method is described in reference to FIGS. 5 and 6, and an example of another such method is described in reference to FIGS. 7 and 8.

In 304, a determination is made whether or not the virtual circuit has bounced (i.e., the DSL link has been dropped or lost). As long as the virtual circuit has not bounced or been released, then no action with respect to the virtual circuit is made by the circuit keeper computer 230. On the other hand, if the virtual circuit is detected to have been bounced, then the circuit keeper computer 230 proceeds back to 302 to activate another available virtual circuit to take the bounced circuit's place, and update the active and available virtual circuit lists accordingly. The circuit keeper computer 230 then sets up the new virtual circuit by performing 303 again, and checks for another circuit bounce by performing 304 again.

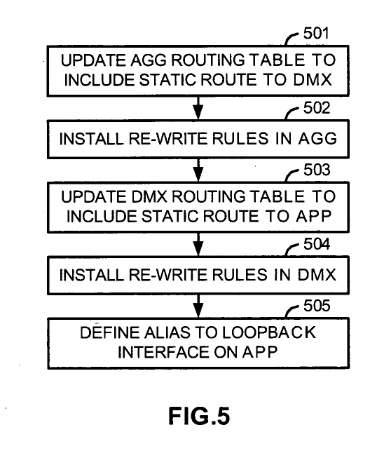

FIG. 4 illustrates, as an example, a flow diagram of a method for releasing an active virtual circuit. The method in this case comprises essentially reverse actions of those taken in activating and setting up the virtual circuit. In 401, the circuit keeper computer 230 receives a virtual circuit release request. In 402, it transmits information and/or instructions to tear down the virtual circuit by removing, for example, all static routes and re-write rules previously provided to computers associated with the virtual circuit. In 403, the circuit keeper computer 230 then updates the virtual circuit lists by removing the virtual circuit from the active circuits list and re-entering it in the available circuits list.

FIG. 5 illustrates a flow diagram of a first method for transmitting information to set-up a virtual circuit to perform 303 of FIG. 3. Note that the following tasks may be handled in the order shown in FIG. 5 or in another order. Also, some or all of the tasks may be performed around the same time so as to be performed substantially concurrently.

In 501, the circuit keeper computer 230 sends information to the aggregator computer 210 to update its routing table to include a static route so that packets addressed to an address associated with the demux computer 240 are sent to the demux computer 240. As previously described, the address in this case may be an aliased address assigned to the virtual circuit if communications to the demux computer 240 are to be sent over the VPN tunnel 220, or it may be a public IP address if communications to the demux computer 240 are to be sent over the public Internet.

In 502, the circuit keeper computer 230 also sends information to the aggregator computer 210 to update its iptables so that packets having a certain destination address associated with the aggregator computer 210 (such as the IP address assigned to one its DSL modems) is re-written from the original destination address to the address associated with the demux computer 240.

In a similar manner, in 503, the circuit keeper computer 230 sends information to the demux computer 240 to update its routing table to include a static route so that packets addressed to an address associated with the application computer associated with the virtual circuit are sent to that application computer. The address in this case is the original destination address.

In 504, the circuit keeper computer 230 also sends re-write information to the demux computer 240 to update its iptables so that packets having the address associated with the demux computer 240 as their destination address are re-written back to the original destination address.

In 505, an application program residing on the application computer that is associated with the virtual circuit assigns the original destination address as an alias to the loopback interface of the application computer, modifies the routing table of the application computer to include to the aliased address, and binds itself to the original destination address and a port of the application computer that is reserved for its use. Consequently, when the application computer receives a packet with the original destination address (i.e., the IP address assigned to a DSL modem of the aggregator computer 210) indicated as its destination address, the kernel of the application computer recognizes that the packet is to be processed locally and passes the packet to the application program that is bound to that original destination address and the previously assigned port.

In order to tear down this virtual circuit, not only are the routing tables and iptables of the aggregator computer 210 and the demux computer 240 placed back into their original form (i.e., before adding the static routes and re-write rules described in reference to FIG. 5), the application computer is also instructed to delete the original destination address alias to its loopback interface, and release the application program so that it is no longer bound to the original destination address and assigned port.

FIG. 6 illustrates, as an example, a flow diagram of a method for communicating over the Internet with devices in a decentralized network that corresponds to the virtual circuit set-up described in reference to FIG. 5. In 601, an IP packet is received at the aggregator computer 210 through its DSL modem 211 from a remote user of client computer 121. The remote user in this example is physically located in Kansas with an IP address of 1.1.1.1, and the aggregator computer 210 and its DSL modem 211 are physically located in Colorado with an IP address of 2.2.2.2 assigned to the DSL modem 211 by its ISP. Therefore, at this time, the IP packet has a source IP address of 1.1.1.1 and a destination IP address of 2.2.2.2.

In 602, before passing the packet to its kernel, the packet header is modified by using the kernel-level packet filter and mangling system iptables of the aggregator computer 210 so that the destination address is rewritten in the IP packet to 172.16.0.3, which is an aliased address assigned during virtual circuit set-up to point to the demux computer 240.

In 603, the packet is then passed to the kernel of the aggregator computer 210 which looks at the source and destination IP addresses indicated in the packet. The kernel, finding that the destination address is not a local address, but one that is in its routing table, passes the packet over the inter-site VPN tunnel 220 to the demux computer 240. At this point, the IP packet has a source IP address of 1.1.1.1 and a destination IP address of 172.16.0.3.

In 604, the packet is received at the demux computer 240, and in 605, its destination IP address is again re-written, this time back to the original destination IP address 2.2.2.2. After the destination IP address is rewritten in the packet, the packet is passed to the kernel of the demux computer 240. The kernel sees that the destination address of the packet is not a local address, but one that is in its routing table,, so in 606, it routes the packet over Ethernet 250 to the application computer 261 that is to process the packet. At this point, the IP packet has its original source IP address of 1.1.1.1 and original destination IP address of 2.2.2.2.

In 607, the application computer receives the incoming packet from the demux computer 240, and its kernel discovers that the packet has a destination IP address that is a local address defined in its routing table as an alias to the loopback interface, and therefore, in 608, it delivers the packet to an application program that resides on the application computer and is bound to the original destination IP address and the correct port. In 609, the application program then processes the packet, and generates a reply packet if appropriate. In 610, the reply packet is then sent back out through the default gateway of the application computer to remote user in Kansas by the kernel of the application computer. The reply packet at this time has a source IP address of 2.2.2.2 and destination IP address of 1.1.1.1, so that it appears that the reply packet is being sent from the DSL model 211 that originally received the packet.

FIG. 7 illustrates a flow diagram of a second and preferred method for transmitting information to set-up a virtual circuit to perform 303 of FIG. 3. One advantage of this method is that it allows the use of the same remote IP address on multiple application computers by including a destination port indication along with the destination address. This is particularly useful where computational sources are at a premium, and bandwidth is available. In method described in FIG. 7, note that the following tasks may be handled in the order shown or in another order. Also, some or all of the tasks may be performed around the same time so as to be performed substantially concurrently.

In 701, the circuit keeper computer 230 sends information to the aggregator computer 210 to update its routing table to include a static route so that packets addressed to an address associated with the demux computer 240 are sent to the demux computer 240. As previously described, the address in this case may be an aliased address assigned to the virtual circuit if communications to the demux computer 240 are to be sent over the VPN tunnel 220, or it may be a public IP address if communications to the demux computer 240 are to be sent over the public Internet.

In 702, the circuit keeper computer 230 also sends information to the aggregator computer 210 to update its iptables so that packets having a certain destination address associated with the aggregator computer 210 (such as the IP address assigned to one its DSL modems) is re-written from the original destination address to the address associated with the demux computer 240.

In a similar manner, in 703, the circuit keeper computer 230 sends information to the demux computer 240 to update its routing table to include static routes pointing to application computers that are associated with the same destination IP address, but different destination ports so that its kernel can determine which of the application computers to route the packet to by looking at the destination port at OSI Layer 4 as well as the destination address at OSI Layer 3.

In 704, the circuit keeper computer 230 also sends re-write rules information to the demux computer 240 to update its iptables so that packets having the address associated with the demux computer 240 as their destination address are re-written so that their respective destination addresses are Ethernet addresses associated with application computers corresponding to their respective destination ports.

In 705, the circuit keeper computer 230 also sends re-write rules information to a remux computer 240 to update its iptables so that packets having the addresses associated with the application computers as their source addresses are re-written to the original destination IP address and destination port. The remux computer 230 in this example serves as a remultiplexing egress router for a common default gateway of the application computers.

In order to tear down this virtual circuit, the routing tables and iptables of the aggregator computer 210, the demux computer 240 and the remux computer 271 are placed back into their original form (i.e., before adding the static routes and re-write rules described in reference to FIG. 7). The application computers are also instructed to release their respective application programs so that they are no longer bound to the original destination address and their assigned ports.

FIG. 8 illustrates, as an example, a flow diagram of a method for communicating over the Internet with devices in a decentralized network that corresponds to the virtual circuit set-up described in reference to FIG. 7. In this example, a first remote user using client computer 121 in the first geographical region 120 sends an IP packet having a source IP address of 1.1.1.1, destination IP address of 2.2.2.2 and destination port 4000, and a second remote user using client computer 122 also in the first geographical region 120 sends a packet having a source IP address of 3.3.3.3, destination IP address of 2.2.2.2 and destination port 5000 to the aggregator computer 210.

Accordingly, there are two virtual circuits used in this example. The first virtual circuit starts with the aggregator computer 210, and ends, for example, with application computer 261. An application program residing on the application computer 261 has initiated this virtual circuit and bound itself, for example, to an Ethernet address and assigned port of the application computer 261. The second virtual circuit, on the other hand, starts with the aggregator computer 210, and ends, for example, with application computer 262. An application program residing on the application computer 262 has initiated this second virtual circuit and bound itself, for example, to an Ethernet address and assigned port of the application computer 262.

In 801, the two IP packets are received at the aggregator computer 210 respectively at its port 4000, for example, from the remote user of client computer 121 through Ethernet 214 and DSL modem 211, and at its port 5000, for example, from the remote user of client computer 122 through Ethernet 214 and DSL modem 212. The first remote user in this example is physically located in Kansas with an IP address of 1.1.1.1, the second remote user is physically located in Missouri with an IP address of 3.3.3.3, and the aggregator computer 210 and its DSL modem 211 are physically located in Colorado with an IP address of 2.2.2.2 assigned to the DSL modem 211 by its ISP. Therefore, at this time, the first IP packet has a source IP address of 1.1.1.1 and a destination IP address of 2.2.2.2, port 4000, and the second IP packet has a source IP address of 3.3.3.3 and a destination IP address of 2.2.2.2, port 5000.

In 802, before passing the packets to its kernel, their packet headers are modified by using the kernel-level packet filter and mangling system iptables of the aggregator computer 210 so that the destination address for both packets is rewritten in the IP packet to 172.16.0.3, which is an aliased address assigned during virtual circuit set-up to point to the demux computer 240. The destination port addresses are not checked or changed at this time.

In 803, the packets are then passed in serial fashion on a first-come-first-served fashion to the kernel of the aggregator computer 210 which looks at the source and destination IP addresses indicated in each packet. The kernel, finding that the destination address in each packet is not a local address, but one that is in its routing table in a static route to the demux computer 240, routes the packets over the inter-site VPN tunnel 220 to the demux computer 240. At this point, the first IP packet has a source IP address of 1.1.1.1 and a destination IP address of 172.16.0.2 with destination port 4000, and the second IP packet has a source IP address of 3.3.3.3 and a destination IP address of 172.16.0.3 with destination port 5000.

In 804, the packets are received at the demux computer 240, and in 805, their destination IP addresses are again re-written before passing the packets to the kernel of the demux computer 240. This time, the destination ports for each of the packets is examined at OSI Layer 4 to determine the application computer that is to process the packet, as well as at OSI Layer 3 to determine their destination IP addresses. For the first packet, its destination port 4000 indicates that it is to be processed by application computer 261, therefore its destination address is re-written to an Ethernet address 172.17.0.2 corresponding to the application computer 261. On the other hand, for the second packet, its destination port 5000 indicates that it is to be processed by application computer 262, therefore its destination address is re-written to an Ethernet address 172.17.0.3 corresponding to the application computer 262.

After the destination IP addresses are rewritten in the packets, the packets are passed to the kernel of the demux computer 240. The kernel sees that the destination addresses of the packets are not a local addresses, but ones that are in its routing table, so in 806, it routes the first packet over Ethernet 250 to the application computer 261 that is to process that packet and it routes the second packet over Ethernet 250 to the application computer 262 that is to process that packet.

In 807, the application computer 261 receives the first packet from the demux computer 240, and its kernel determines that the packet has a destination IP address that is a local address. Therefore, in 808, it delivers the packet to an application program that is bound to its Ethernet address and the correct port. Also, in 807, the application computer 262 receives the second packet from the demux computer 240, and its kernel also determines that the packet has a destination IP address that is a local address. Therefore, in 808, it also delivers its packet to an application program that is bound to its Ethernet address and the correct port.

In 809, the application programs on the application computers 261 and 262 then process their respective packets, and generate reply packets if appropriate. The reply packets are then passed back to their respective kernels, and in 810, each of the kernels sends its respective reply packet out through a common default gateway, which is pointed at the remultiplexing egress router (“remux”) computer 271. Each of the reply packets at this point has its source and destination IP addresses reversed so that the first reply packet has a source IP address of 172.17.0.2 (i.e., the Ethernet address of the application computer 261) with source port 4000 and a destination IP address of 2.2.2.2 (i.e., the IP address of the client computer 121), and the second reply packet has a source IP address of 172.17.0.3 (i.e., the Ethernet address of the application computer 262) with source port 5000 and a destination IP address of 3.3.3.3 (i.e., the IP address of the client computer 122).

In 811, the reply packets are received at the remux computer 271. Before passing the reply packets to their respective kernels, in 812, the packet filter of the remux computer 271 first re-writes their source addresses according to re-write rules previously provided to the remux computer 271 during set up of the two virtual circuits. Accordingly, the source IP address of the first reply packet is re-written from the Ethernet address 172.17.0.2 to 2.2.2.2, leaving the source port 4000 unchanged. Likewise, the source IP address of the second reply packet is re-written from the Ethernet address of 172.17.0.3 to 2.2.2.2, leaving the source port 5000 unchanged.

In 813, the reply packets are then passed back to the kernel of the remux computer 271. Since the kernel determines that both reply packets have destination addresses that are not local, it passes both reply packets out its default gateway to be sent back to their respective destination IP addresses. At this time, the first reply packet has a source IP address of 2.2.2.2 with source port 4000 and destination IP address of 1.1.1.1, so that it appears to the client computer 121 at the destination IP address that the reply packet is being sent from the DSL modem 211 that received its corresponding original packet. Likewise, the second reply packet has a source IP address of 2.2.2.2 with source port 5000 and destination IP address of 3.3.3.3, so that it appears to the client computer 122 at the destination IP address that the reply packet is being sent from the DSL modem 212 that received its corresponding original packet.

Although the various aspects of the present invention have been described with respect to a preferred embodiment, it will be understood that the invention is entitled to full protection within the full scope of the appended claims.

1. A system for communicating with devices in a decentralized network, comprising:
a plurality of remote capture centers geographically distributed so as to receive communications from devices of a decentralized network that reside in diverse geographical locations; and
a centralized data center communicating with the plurality of remote capture centers so as to generate processed information from the communications received at the plurality of remote capture centers from the devices and transmit the processed information back to the devices in a manner such that the processed information appears to have been transmitted from the plurality of remote capture centers.

2. The system according to claim 1, wherein the devices of the decentralized network are organized by their respective IP addresses into geographical regions, and the plurality of remote capture centers are distributed among the geographical regions so as to communicate with devices in their respective geographical regions.

3. The system according to claim 2, wherein individual of the plurality of remote capture centers includes an aggregator computer configured to receive information from devices in its geographical region.

4. The system according to claim 3, wherein the centralized data center includes:
an application computer; and
a demux computer communicating with the aggregator computer so as to route the information to the application computer.

5. The system according to claim 4, wherein the aggregator computer receives a packet of information from one of the devices and re-writes a destination address indicated in the packet from an original destination address associated with the aggregator computer to an address associated with the demux computer, and routes the packet to the demux computer.

6. The system according to claim 5, wherein the aggregator computer routes the packet to the demux computer through a virtual private network tunnel and the address associated with the demux computer is an aliased address associated with the demux computer.

7. The system according to claim 5, wherein the aggregator computer routes the packet to the demux computer over the Internet and the address associated with the demux computer is an IP address of the demux computer.

8. The system according to claim 5, wherein the aggregator computer routes the packet to the demux computer according to a first static route defined in a routing table of the aggregator computer.

9. The system according to claim 5, wherein the demux computer re-writes the destination address indicated in the packet from the address associated to the demux computer back to the original destination address, and routes the packet to the application computer.

10. The system according to claim 9, wherein the demux computer routes the packet to the application computer according to a second static route defined in a routing table of the demux computer.

11. The system according to claim 10, wherein an alias on the loopback interface of the application computer is designated as the original destination address.

12. The system according to claim 5, wherein the demux computer re-writes the destination address indicated in the packet from the address associated to the demux computer to an address associated with the application computer, and routes the packet to the application computer.

13. The system according to claim 12, wherein the demux computer determines the address associated with the application computer using a destination port indicated in the packet.

14. The system according to claim 13, wherein the demux computer and the application computer communicate through an Ethernet network, and the address associated with the application computer is an Ethernet address associated with the application computer.

15. The system according to claim 14, wherein an application program residing on the application computer processes information in the packet to generate a reply packet, and routes the reply packet to a remux computer of a default gateway of the application computer.

16. The system according to claim 15, wherein the remux computer re-writes the source address indicated in the reply packet to be the original destination address according to re-write rules provided to the remux computer, and passes the reply packet out the default gateway so as to be sent back to the device that originally sent the packet of information to the aggregator computer.

17. The system according to claim 4, wherein the centralized data center further includes an administrative computer that manages a list of virtual circuits wherein one of the virtual circuits on the list corresponds to the routing of the packet from the aggregator computer to the application computer.

18. The system according to claim 17, wherein the administrative computer activated the virtual circuit corresponding to the routing of the packet from the aggregator computer to the application computer upon request by the application computer, and brought up the virtual circuit by providing re-write rules and static routes to the aggregator computer and the demux computer.

19. The system according to claim 18, wherein the administrative computer brought up the virtual circuit by also providing re-write rules to a remux computer of a default gateway of the application computer.

20. A method for communicating with devices in a decentralized network, comprising:
receiving a packet from a device;
routing the packet to a centralized data center;
generating a reply packet by processing information in the packet; and
transmitting the reply packet back to the device using a transparent asymmetric return path.

21. The method according to claim 20, wherein the receiving of the packet from the device is performed at a remote capture center and the reply packet indicates a source IP address associated with the remote capture center and a destination IP address associated with the device.

22. The method according to claim 21, wherein the routing of the packet to the centralized data center includes rewriting a destination address in the packet from an original destination address to an address associated with the centralized data center.

23. The method according to claim 22, wherein the rewriting of the destination address is performed in accordance with re-write rules provided to the remote capture center.

24. The method according to claim 22, wherein the routing of the packet to the centralized data center includes routing the packet to the centralized data center according to a first static route defined in a routing table of a computer in the remote capture center.

25. The method according to claim 22, wherein the generating of the reply packet comprises:
rewriting the destination address in the packet from the address associated with the centralized data center to an address associated with an application computer in the centralized data center;
routing the packet to the application computer; and
processing the packet with an application program residing on the application computer to generate the reply packet.

26. The method according to claim 25, wherein the packet is routed to the application computer according to a static route defined in a routing table of a computer in the centralized data center.

27. The method according to claim 25, further comprising designating the original destination address as an alias on the loopback interface of the application computer.

28. The method according to claim 27, wherein the address associated with the application computer is the original destination address.

29. The method according to claim 25, wherein the computer in the centralized data center and the application computer communicate through Ethernet interfaces, and the address associated with the application computer is an Ethernet address assigned to the application computer.

30. The method according to claim 29, further comprising: determining the Ethernet address using information of a destination port indicated in the packet.

31. The method according to claim 30, wherein transmitting the reply packet back to the device comprises:
passing the reply packet to a remux computer in a default gateway of the application computer; and
re-writing the source IP address of the reply packet so as to include the original destination address associated with the remote capture center according to re-write rules provided to the remux computer.

32. A method for communicating with devices in a decentralized network, comprising:
receiving a request to establish a virtual circuit including a first computer in a remote capture center, a second computer in a centralized data center, and an application computer initiating the request; and
sending first re-write rules to the first computer and second re-write rules to the second computer when establishing the virtual circuit so that the first re-write rules cause the first computer to re-write a destination address included in a packet of information received from a device in the decentralized network to be re-written from an original destination address to an address associated with the second computer, and the second re-write rules cause the second computer to re-write the destination address from the address associated with the second computer to an address associated with the application computer after receiving the packet from the first computer.

33. The method according to claim 32, further comprising sending a first static route to the first computer and a second static route to the second computer when establishing the virtual circuit so that the first re-static route instructs the first computer to route the packet received from the device to the second computer, and the second static route instructs the second computer to route the packet to the application computer after receiving the packet from the first computer.

34. The method according to claim 32, further comprising designating the original destination address as an alias on a loopback interface of the application computer so that the address associated with the application computer is the original destination address.

35. The method according to claim 32, wherein the address associated with the application computer is an Ethernet address, and further comprising sending third re-write rules to a third computer of a default gateway of the application computer so that the third computer re-writes a source address in a reply packet generated by the application computer from the Ethernet address associated with the application computer to the original destination address.

36. A method for generating a reply packet, comprising:
receiving a packet from a remote capture center that has re-written a destination address in the packet from an original destination address associated with the remote capture center to an address associated with a first node of a centralized network;
re-writing the destination address from the address associated with the first node to an address associated with a second node of the centralized network;
routing the packet over the centralized network to the second node according to a static route defined in a routing table of the first node; and
generating a reply packet by processing information in the packet using an application program residing on the second node.

37. The method according to claim 36, further comprising: sending the reply packet through a default gateway of the second node back to a device that sent the packet to the remote capture center with a source address of the reply packet indicating the original destination address.

38. The method according to claim 37, further comprising: designating the original destination address as an alias on the loopback interface of the second node, and the address associated with the second node is the original destination address.

39. The method according to claim 37, further comprising: re-writing the source address in the reply packet from the address associated with the second node to the original destination address before sending the reply packet through the default gateway of the second node back to the device that sent the packet to the remote capture center.

40. The method according to claim 39, wherein the centralized network is an Ethernet network and the address associated with the second node is an Ethernet address.

41. The method according to claim 40, further comprising: determining the Ethernet address using information included in a destination port indicated in the packet.

42. The method according to claim 36, wherein the receiving of the packet from the remote capture center is received by the first node of the centralized network over the Internet, and the address associated with the first node is an IP address.

43. The method according to claim 36, wherein the receiving of the packet from the remote capture center is received by the first node of the centralized network through a virtual private network over the Internet, and the address associated with the first node is an aliased address.
